(19) United States
(12) Patent Application Publication
(10) Pub. No.: US 2015/0257334 A1
(43) Pub. Date: Sep. 17, 2015

(54) FLOW MONITORING AND CONTROL SYSTEM FOR AGRICULTURAL IMPLEMENTS

(71) Applicant: SureFire Ag Systems, Inc., Atwood, KS (US)

(72) Inventors: Joshua J. Wolters, Atwood, KS (US); Blaine C. Ginther, Atwood, KS (US); Matthew W. Wolters, Atwood, KS (US); Albert E. Popp, Atwood, KS (US)

(73) Assignee: SUREFIRE AG SYSTEMS, INC., Atwood, KS (US)

(21) Appl. No.: 14/657,514

(22) Filed: Mar. 13, 2015

Related U.S. Application Data
(60) Provisional application No. 61/953,320, filed on Mar. 14, 2014.

(51) Int. Cl. A01C 23/02

(52) U.S. Cl. CPC A01C 23/023

(57) ABSTRACT

An improved dual metering tube systems for use in directing liquid to the row units of an agricultural implement uses metering tubes of different diameters, a pressure sensor to sense the pressure in a trunk line through which liquid is fed to the metering tubes and a controller for operating one or more valves to selectively direct liquid through only a set of small diameter tubes, only a set of large diameter tubes or both the small and large diameter tubes. Each of the small diameter tubes is paired with a respective one of the large diameter tubes and flow connected to a common outlet or nozzle associated with a respective row unit.

### CROSS-REFERENCE TO RELATED APPLICATIONS

This application claims the benefit of U.S. provisional patent application Ser. No. 61/953,320, filed Mar. 14, 2014, under 35 U.S.C. §119(e).

### BACKGROUND OF THE INVENTION

1. Field of the Invention

This invention relates to equipment for delivering liquid products, such as fertilizers or pesticides, to and discharging the liquid products at individual rows of an agricultural implement such as a planter.

2. Description of the Related Art

Planters and other row type agricultural implements are commonly outfitted with liquid dispensing systems for distributing liquid agricultural chemicals, such as liquid fertilizer, to each row unit and dispensing the liquid in close proximity to the row unit. Such liquid dispensing systems typically include a tank for holding the liquid, a pump for pumping liquid from the tank, a plurality of branched distribution lines through which the liquid is distributed to a plurality of nozzles or delivery tubes. The liquid is dispersed out of the nozzle or delivery tube onto the field.

Precision agriculture techniques sometimes require widely varying amounts of a chemical to be applied in different sections of the same field. For example, the farmer may want to apply 5 gallons per acre (GPA) in one area and apply 35 GPA in another area of the same field. The farmer may also operate at a minimum speed of 4 miles per hour (MPH) in one section, but increase to a maximum speed of 10 MPH in another. This combination of changes in application rate and speed at which the implement traverses the field requires a very large change in liquid flow.

The ability to measure variations in the amount of liquid delivered is easily accomplished with existing flow meters. Likewise, pumps can be controlled to deliver the total volume of liquid necessary over a very wide range of total product flow.

However, existing systems are not adequate to divide the total flow for an implement (for example a 24 row, 60 foot wide corn planter) down to 24 equal flows to apply to each row or application point the farmer desires. A basic system currently in use to control flow is an orifice disc with an equal size orifice for each application point. The orifice creates back pressure in the liquid distribution tubes then the pressure created produces equal flow through each equal sized orifice. However, fluid dynamics works such that a four-fold increase in pressure is required to gain a two-fold increase in flow. Given that the maximum total pressure is practically limited to under 100 psi with the components typically used in these systems, the maximum flow difference that can be generated by pressure changes is limited. The typical response has been to limit the range of liquid applied to what one orifice can accomplish. Then the farmer can change each orifice disc to a different size if they needed to change their application rate. This process is messy, time consuming and not practical within a single field.

There have been improvements on the standard orifice disc. One is to use a spring controlled variable orifice. An example of this type of device is shown in U.S. Pat. No. 7,124,964 to Quy Duc Bui. These devices advertise a wider flow range for a given pressure difference than a standard orifice disc. However, in the field they do not always produce sufficiently equal flows at each row to satisfy the farmer's needs.

Another product used to achieve this goal is the fluid flow divider sold by John Blue Company and described in U.S. Pat. No. 6,311,716 of Kent R. Jones assigned to John Blue Company. However, these devices are believed to lose row-to-row accuracy at lower application rates.

It is also known to use a metering tube to improve upon the traditional orifice disc. This is a tube with a specific inside diameter, that is of a substantial length (four to twelve feet is typical). This provides the same pressure drop function as an orifice to create equal row-to-row distribution. However, due to flow dynamics in a tube versus an orifice, an equal pressure range will produce a greater flow range in the tube versus the orifice disc. This allows the farmer to achieve greater variability in liquid application rates and implement speeds with the metering tube compared to the traditional orifice disc.

It is also known to use dual metering tube systems comprising two metering tubes of different internal diameter for each row. A manually operated valve is used in such systems to selectively direct the flow through only the first tube or only the second tube or through both the first and second tubes allowing the operator to achieve wider flow rates through the tubing at each row unit. However, the manual setting of the system requires the operator to correctly assess which selection of tubes is appropriate and may require the operator to manually readjust the valves when the desired application rates change.

### SUMMARY OF THE INVENTION

The present invention comprises an improvement to dual metering tube systems for use in directing liquid to the row units of an agricultural implement which uses metering tubes of different diameters, a pressure sensor to sense the pressure in a trunk line through which liquid is fed to the metering tubes and a controller for operating one or more valves to selectively direct liquid through only a set of small diameter tubes, only a set of large diameter tubes or both the small and large diameter tubes. Each of the small diameter tubes is paired with a respective one of the large diameter tubes and flow connected to a common outlet associated with a respective row unit.

The one or more valves are advanceable between a low flow state in which liquid is only delivered to the set of small diameter tubes, a medium flow state in which liquid is only delivered to the set of large diameter tubes; or a high flow state in which liquid is delivered to both the small diameter tubes and the large diameter tubes. A controller communicates with the pressure sensor and the one or more valves to control the one or more valves to initially position the one or more valves in the low flow state. When the one or more valves are in the low flow state, if the pressure sensed by the pressure sensor exceeds a maximum set pressure the controller advances the one or more valves to the medium flow state. When the one or more valves are in the medium flow state, if the pressure sensed by the pressure sensor exceeds the maximum set pressure to advance the one or more valves to the high flow state or if the pressure sensed by the pressure sensor falls below a minimum set pressure to advance the one or more valves to the low flow state. Finally, when the one or more valves are in the high flow state, if the pressure sensed by the pressure sensor falls below a minimum set pressure to advance the valves to the medium flow state.

In one embodiment, the set of small diameter tubes includes at least first and second sets of small diameter tubes and the set of large diameter tubes includes at least first and second sets of large diameter tubes. Separate valves are associated with each set of small diameter tubes and each set of large diameter tubes. The controller communicates with the pressure sensor valves associated with each set of small diameter tubes and with each set of large diameter tubes to initially open only the valves associated with the small diameter tubes. When only the valves associated with the small diameter tubes are open, if the pressure sensed by the pressure sensor exceeds a maximum set pressure, the controller closes the valves associated with the small diameter tubes and opens the valves associated with the large diameter tubes. When only the valves associated with the large diameter tubes are open, if the pressure sensed by the pressure sensor exceeds the maximum set pressure, the controller opens the valves associated with the small diameter tubes while leaving the valves associated with the large diameter tubes open or if the pressure sensed by the pressure sensor falls below a minimum set pressure, the controller opens the valves associated with the small diameter tubes and closes the valves associated with the large diameter tubes. When both the valves associated with the large diameter tubes and the valves associated with the small diameter tubes are open, if the pressure sensed by the pressure sensor falls below a minimum set pressure the controller closes the valves associated with the small diameter tubes while leaving the valves associated with the large diameter tubes open.

The valves are preferably mounted on a mounting bracket which is mounted centrally or at a single location on the row unit type agricultural implement as opposed to mounting separate valves for each pair of small diameter and large diameter tubes at or near each row unit. The mounting bracket includes the valves associated with the small diameter tubes mounted in a first section or column of the bracket and the valves associated with the large diameter tubes mounted in a second section or column of the bracket.

### BRIEF DESCRIPTION OF THE DRAWINGS

FIG. 1 is a partially schematic perspective view of a liquid distribution system configured to distribute liquid agricultural chemicals to each row of a row type agricultural implement including a front perspective view of a manifold and valve assembly used in the liquid distribution system for supplying liquid to each row of an eight row implement with the rows split into two, four row sections.

FIG. 2 is a view similar to FIG. 1 showing a rear perspective view of the manifold and valve assembly.

FIG. 3 is a logic diagram for the operating valves of the liquid distribution system.

FIG. 4 is a front perspective view of an alternative embodiment of the manifold and valve assembly adapted for supplying liquid to an implement having four sections of multiple rows in each section.

FIG. 5 is a front elevational view of the manifold and valve assembly as shown in FIG. 4.

FIG. 6 is a rear elevational view of the manifold and valve assembly as shown in FIG. 4.

FIG. 7 is a left side elevational view of the manifold and valve assembly as shown in FIG. 4

FIG. 8 is a schematic view of an alternative embodiment of a liquid distribution system for row type agricultural implements.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

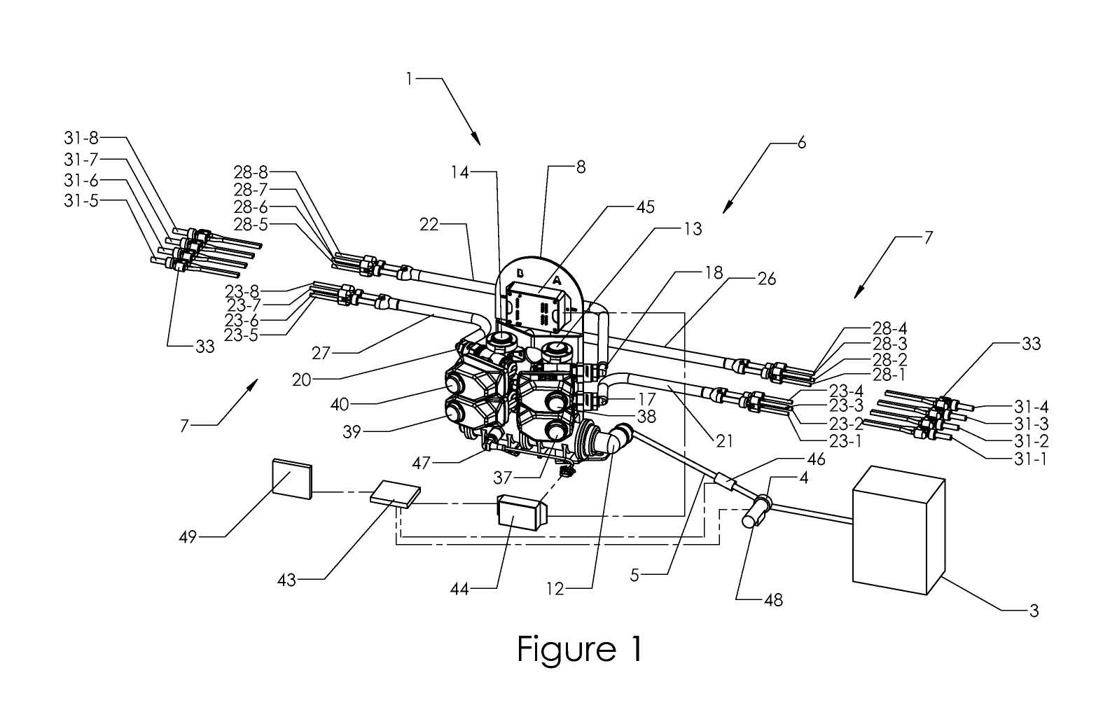

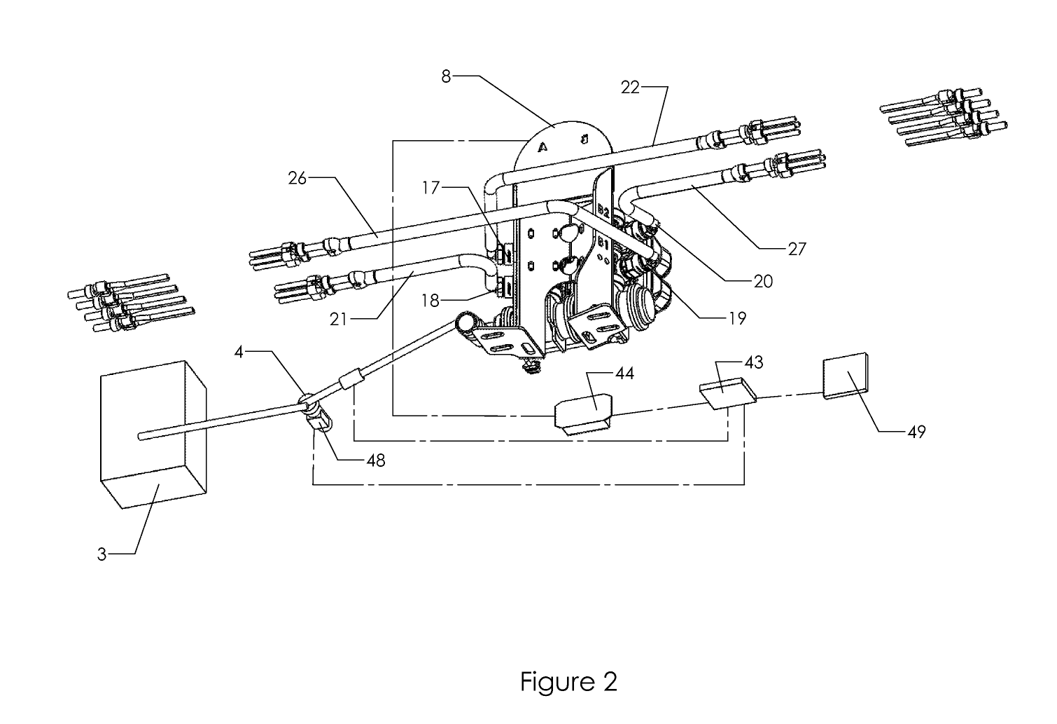

Referring to the drawings in more detail, FIG. 1 is a partially schematic view of a liquid distribution system 1 for mounting on a row type agricultural implement (not shown). The liquid distribution system 1 includes a tank 3, pump 4, main feed line 5, manifold and valve assembly 6 and liquid distribution lines 7 which are routed to each row or row unit (not shown) of the implement. The system 1 shown in FIGS. 1 and 2 is adapted for dispensing liquid at or near each row of an agricultural implement having eight rows split into two sections of four.

The components of the manifold and valve assembly 6 are mounted on a mounting bracket 8 which is configured to be bolted or otherwise secured to the frame of the agricultural implement. The manifold and valve assembly 8 includes a manifold 11 having a manifold trunk 12 and first and second manifold branches 13 and 14 extending from manifold trunk 12. The first manifold branch 13, or A branch, has first and second outlet tube connectors 17 and 18 connected thereto and the second manifold branch 14, or B branch, has third and fourth outlet tube connectors 19 and 20 connected thereto.

First and second group A distribution lines 21 and 22 for routing liquid to smaller diameter branch lines 23 associated with the first and second row sections are connected to first and second outlet tube connectors 17 and 18 respectively. First group A distribution line 21 branches out into four smaller diameter branch lines 23-1, 23-2, 23-3 and 23-4 (first group A branch lines) and second group A distribution line 22 branches out into four smaller diameter branch lines 23-5, 23-6, 23-7 and 23-8 (second group A branch lines). Similarly, first and second group B distribution lines 26 and 27 are connected to third and fourth outlet tube connectors 19 and 20 respectively. First group B distribution line 26 branches out into four larger diameter branch lines 28-1, 28-2, 28-3 and 28-4 (first group B branch lines) and second group B distribution line 27 branches out into four larger diameter branch lines 28-5, 28-6, 28-7 and 28-8 (second group B branch lines). The internal diameter of each smaller diameter branch line 23-1 through 23-8 is smaller than the internal diameter of each larger diameter branch line 28-1 through 28-8. However, the internal diameter of each group A distribution lines 21 and 22 is preferably the same as the internal diameter of the group B distribution lines 26 and 27 so that the pressure drop through distribution lines 21 and 22 and 26 and 27 are generally the same.

Each of smaller diameter branch line 23-1 through 23-8 is paired with a larger diameter branch line 28-1 through 28-8 and routed to a row or row unit. For example the following branch lines may be paired together and each pair routed to a row unit: 23-1 and 28-1; 23-2 and 28-2; 23-3 and 28-3; 23-4 and 28-4; 23-5 and 28-5; 23-6 and 28-6; 23-7 and 28-7; and 23-8 and 28-8. At each row unit, the associated pairs of smaller diameter and larger diameter branch lines are connected to a single nozzle or applicator tube 31 with a Y-connector 33. Branch lines 23-1 and 28-1 are connected to applicator tube 31-1; branch lines 23-2 and 28-2 are connected to applicator tube 31-2; branch lines 23-3 and 28-3 are connected to applicator tube 31-3; branch lines 23-4 and 28-4 are connected to applicator tube 31-4; branch lines 23-5 and 28-5 are connected to applicator tube 31-5; branch lines 23-6 and 28-6 are connected to applicator tube 31-6; branch lines 23-7 and 28-7 are connected to applicator tube 31-7; and branch lines 23-8 and 28-8 are connected to applicator tube 31-8.

First and second valves 37 and 38, or group A valves, are connected to the first manifold branch 13 and control flow of liquid out the first and second outlet tube connectors 17 and 18 respectively and to the first and second group A distribution lines 21 and 22. Third and fourth valves 39 and 40, or group B valves, are connected to the second manifold branch 14 and control flow of liquid out the second and third outlet tube connectors 19 and 20 respectively and to the first and second group B distribution lines 26 and 27.

A primary rate controller 43, a pressure controller 44 and a valve controller 45 are used to control the flow of liquid through the liquid distribution lines 7 and out applicator tubes 31-1 through 31-8 based at least in part on the flow rate of the liquid in the main feed line 5 sensed by flow meter 46 and the pressure of the liquid in the main feed line 5 sensed by pressure sensor 47. In the embodiment shown, flow meter 46, measures the flow rate of liquid in the main feed line 5, downstream of pump 4. The primary controller 43 receives a signal from the flow meter 46 indicative of the flow rate of liquid in main feed line 5. Primary controller 43 communicates with the motor 48 for pump 4 to vary the speed of the pump, to vary the flow rate through the system and to create backpressure.

Pressure sensor 47 is mounted on and extends into the manifold trunk 12. The pressure controller 44 receives a signal from pressure sensor 47 indicative of the pressure of the liquid in main feed line 5. Pressure controller 44 communicates the sensed pressure to primary rate controller 43 and valve controller 45. Primary rate controller 43 communicates the sensed pressure to computer display 49 to display the information to an operator. Valve controller 45 communicates with and selectively opens and closes each of the valves 37-40 in response to changes in the pressure sensed by pressure sensor 47.

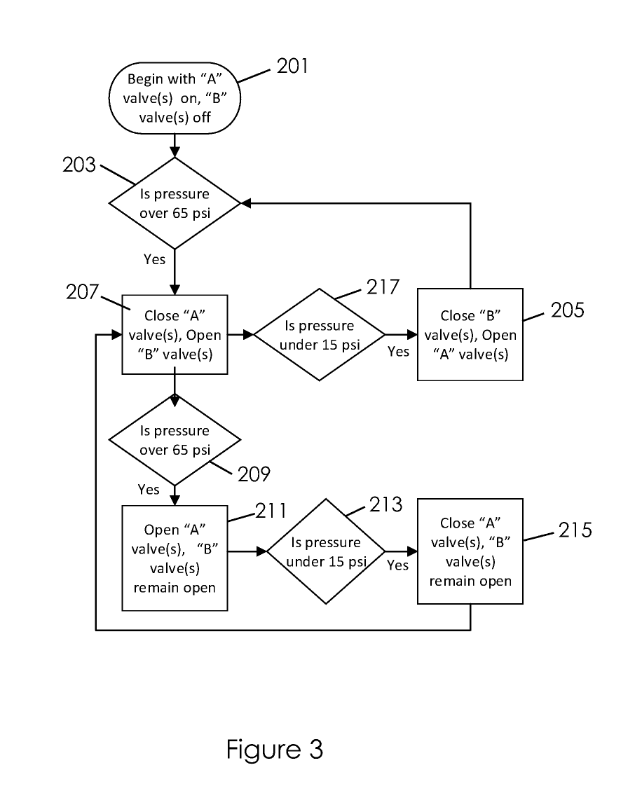

Operation of the system is described hereafter with reference to FIG. 3 which comprises a logic diagram for the valve controller 45 of the embodiment shown in FIGS. 1 and 2. In an initial step 201, first and second valves 37 and 38, or A valves, are set open to allow liquid to flow through the group A distribution lines 21 and 22 and the smaller diameter branch lines 23-1 through 23-8 and third and fourth valves 39 and 40, or B valves, are closed to prevent liquid from flowing through the group B distribution lines 26 and 27 and the larger diameter branch lines 28-1 through 28-8. The pressure in group A distribution lines 21 and 22 and branch lines 23, will increase as the rate controller 43 increases the pump speed and liquid flow. When the pressure sensed by pressure sensor 47 at 203 and communicated to valve controller 45 reaches a high pressure set-point, the valve controller will open the group B valves 39 and 40 at 205 allowing liquid to flow through group B distribution lines 26 and 27 and larger diameter branch lines 28-1 through 28-8 and closes the group A valves 37 and 38 at 207 preventing liquid from flowing through the group A distribution lines 21 and 22 and through the smaller diameter branch lines 23.

Because of the increase in the internal diameter of the tubing of the larger diameter branch lines 28 versus the smaller diameter branch lines 23, the pressure in the distribution lines 7 and the main feed line 5 will initially decrease. If the pump speed is increased to further increase the flow rate of liquid through the distribution lines 7, the pressure in the main feed line 5 will continue to increase. When the pressure sensed by pressure sensor 47 in the main feed line 5 reaches the high pressure set-point again at 209, valve controller 45 will, at 211, re-open the group A valves 37 and 38, while leaving the group B valves 39 and 40 open so that liquid flows through both sets of distribution lines 21, 22, 26 and 27 and both sets of smaller and larger diameter branch lines 23 and 28. In one embodiment the high pressure set point, might range between 50 to 75 psi and in the embodiment shown in FIG. 3 is set at 65 psi for demonstrative purposes.

With both group A and B valves 37-40 open, and when the flow is reduced by the rate controller, the pressure in the main feed line 5 and distribution lines 7 will drop. When the pressure sensed in the main feed line 5 by pressure sensor 47 drops below a minimum pressure set point as at 213, the valve controller 45 is programmed to close the group A valves at 215, blocking flow through the smaller diameter branch lines 23. Once the group A valves are closed, the pressure in the group B distribution lines and the larger diameter branch lines 28 will initially increase to a pressure exceeding the minimum pressure set point, which in the embodiment shown in FIG. 3 is set at 15 psi for demonstrative purposes. It is foreseen that set points ranging from approximately 10 to 20 psi could be utilized for the minimum pressure set point and that set points ranging from approximately 50 to 80 could be utilized for the maximum pressure set point. If flow continues to drop, the back pressure in the tubes will also continue to drop. When the pressure sensed in the main feed line 5 by pressure sensor 47 drops back down to the minimum set-point as at 217, valve controller 45 will open the group A valves allowing flow to the smaller diameter branch lines and will close the group B valve resulting in increased back pressure throughout the distribution lines 7.

It is foreseen that a single valve could be utilized to control the flow of liquid to multiple group A or group B distribution lines. The valves used may be controlled electrically, hydraulically, pneumatically or by other known means. It is also foreseen that a single valve could be used to control the fluid to all of the lines with the valve having a first position in which the main feed line or trunk line is connected to each of and only the smaller diameter branch lines, a second position in which the main feed line is connected to each of and only the larger diameter branch lines, a third position in which the main feed line is connected to each of the smaller diameter branch lines and each of the larger diameter branch lines, and a fourth or closed position in which flow is cut off between the main feed line and the smaller diameter branch lines and the larger diameter branch lines. It is also foreseen that one such four way valves could be connected between the main feed line and each paired set of group A distribution lines and group B distribution lines, or in other words one four way valve per set of group A and group B distribution lines.

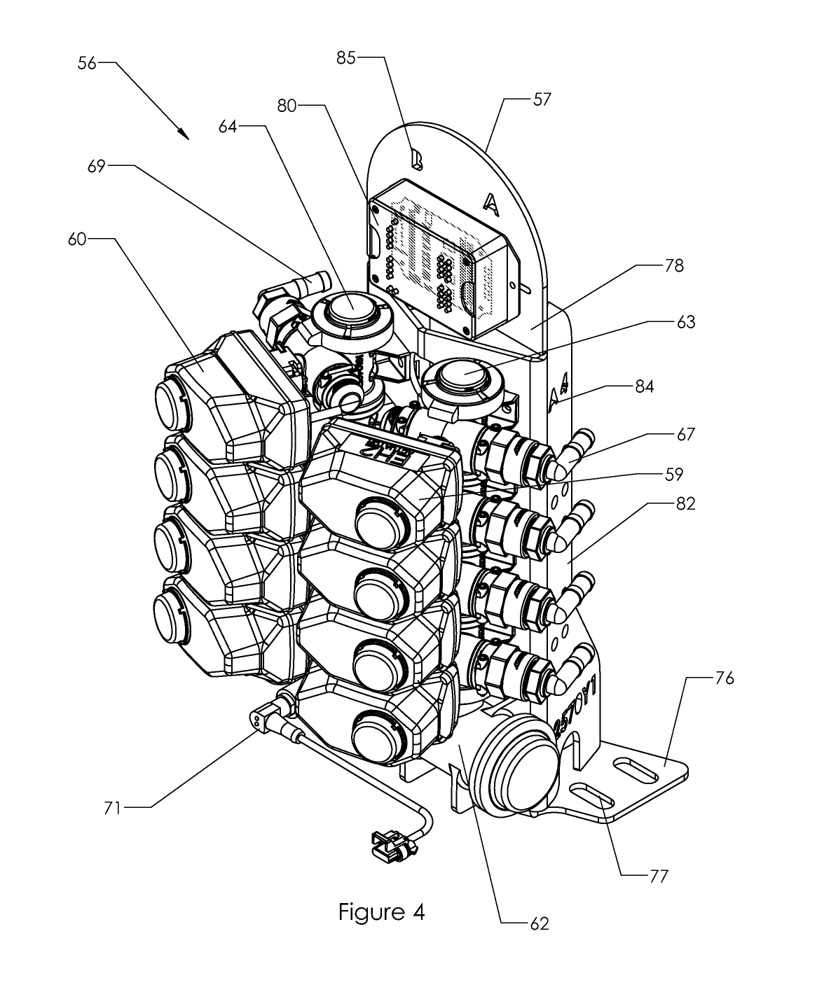

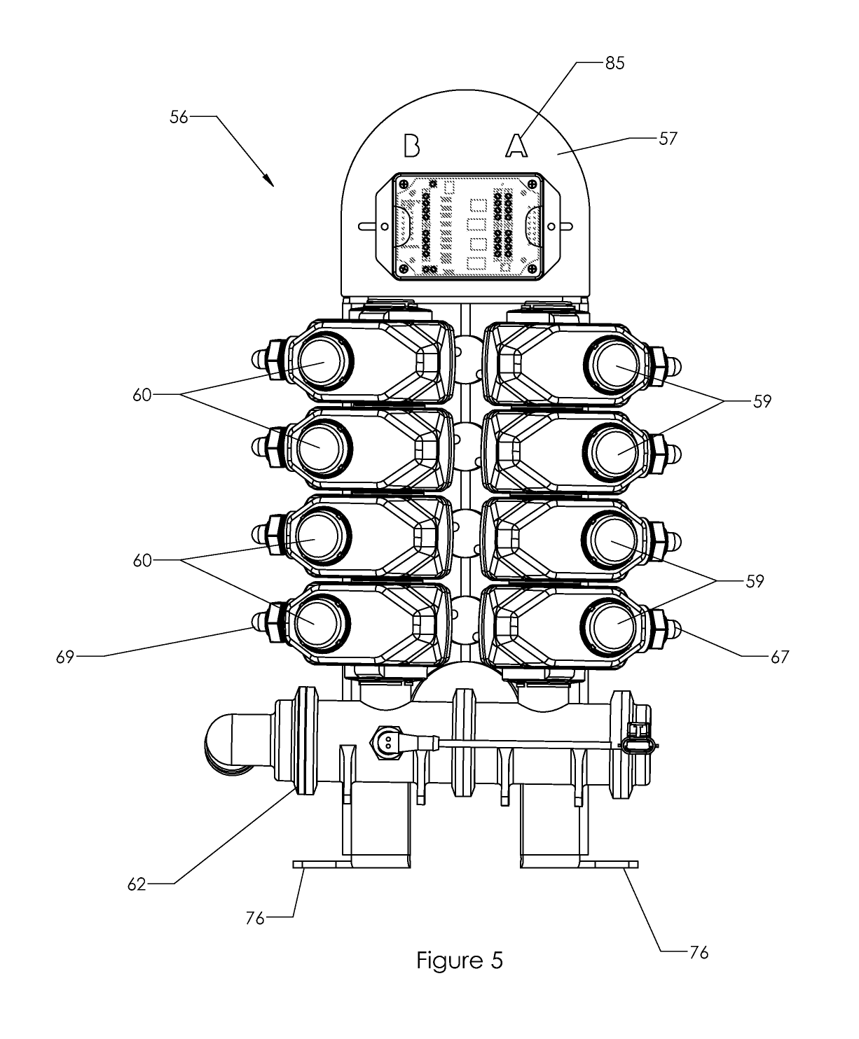

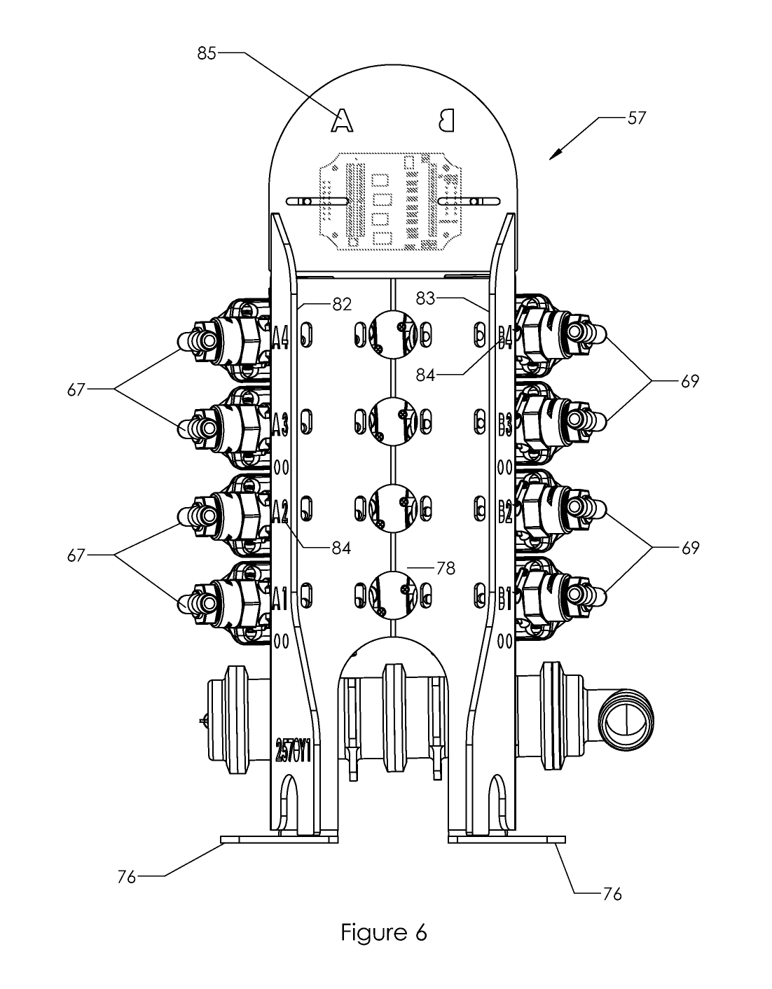

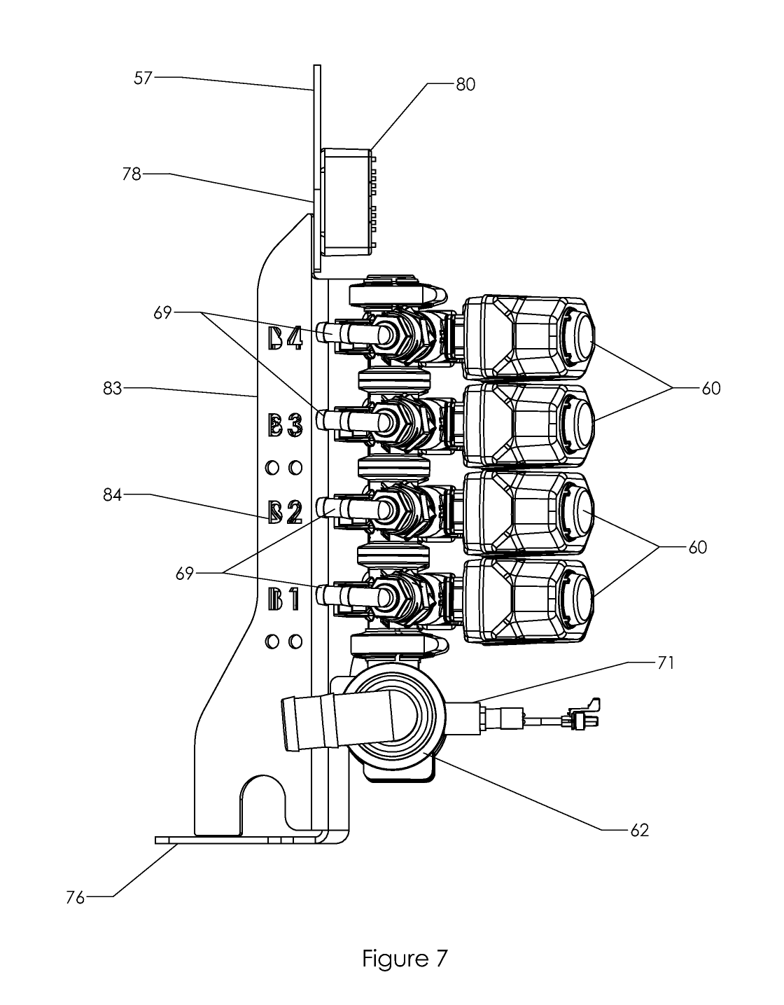

FIGS. 4-7 disclose an alternative embodiment of a manifold and valve assembly 56 mounted on a larger bracket 57. Manifold and valve assembly 56 includes four sets of group A valves 59 and four sets of group B valves 60 mounted on longer manifold branches 63 and 64 respectively projecting from manifold trunk 62. Four sets of outlet tube connectors 67 and 69 are mounted on each manifold branch 63 and 64 respectively for connecting four sets of group A and group B distribution lines and branches (not shown) thereto. A pressure sensor 71 is shown mounted on the manifold trunk 62. The manifold and valve assembly 56 are adapted to distribute liquid to each row of four sets of four row sections of the implement.

The mounting bracket 57 includes a pair of slotted mounting bracket feet 76. The slots 77 in feet 76 receive screws for bolting the bracket 57 to an implement frame. A vertical mounting plate 78 projects upward from the feet 76 and is adapted for mounting of the manifold trunk 62 and manifold branches 63 and 64 thereto. A valve controller 80 is mounted on the vertical mounting plate 78 at an upper end thereof. Side flanges 82 and 83 project rearward from the vertical mounting plate 78 on opposite sides thereof and are angled slightly inward towards each other. The side flanges 82 and 83 provide structural rigidity and strength to the bracket 57. Valve position indicia 84 are shown stamped into the side flanges 82 and 83 to provide a reference to each valve 59 and 60 mounted on the bracket 57. In the embodiment shown, the indicia include references A1, A2, A3 and A4 on one side flange 82 indicative of each of the group A valves 59 mounted adjacent thereto and references B1, B2, B3 and B4 on the other side flange 83 indicative of each group B valve 60. A and B indicia 85 is also shown formed at the top of the bracket, to indicate which group of valves are included in each column and the group of distribution lines controlled thereby.

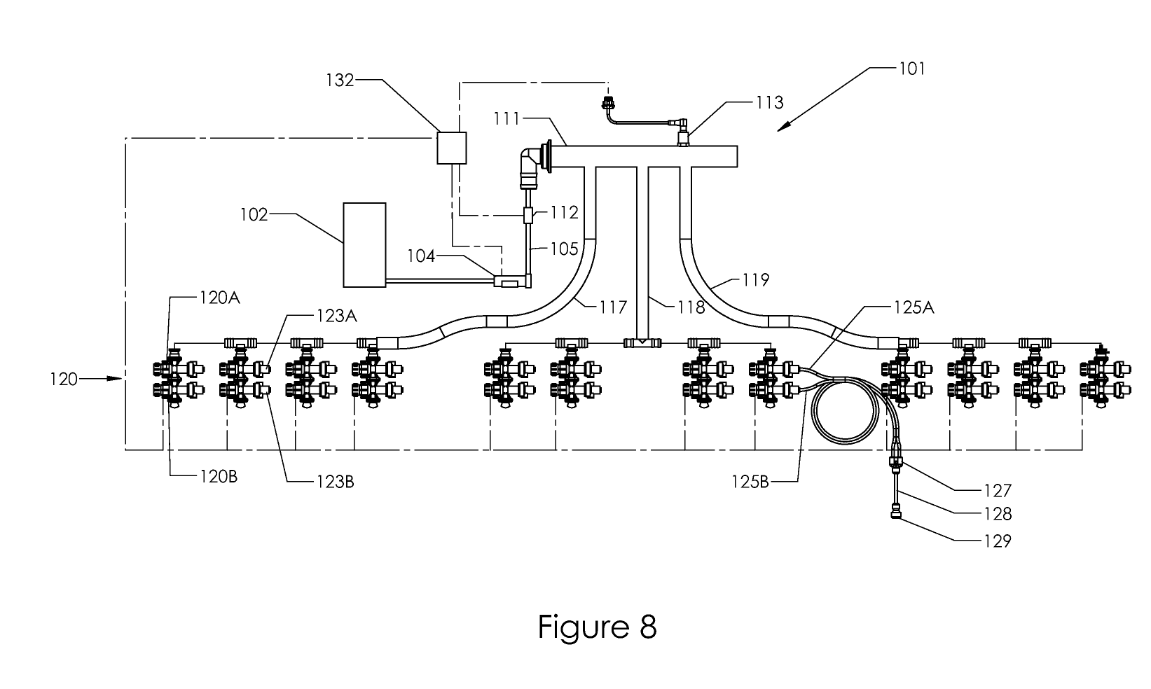

FIG. 8 is an alternative embodiment of a liquid distribution system 101 for distributing liquid agricultural chemicals to each row of a row type implement in which the valves for controlling the flow of liquid out each line are mounted at each row instead of on a centrally mounted manifold and valve assembly as in the first two embodiments discussed herein. In system 101, liquid is pumped from a tank 102, using pump 104 and through main feed line 105 to a manifold 111. A flow meter 112 is mounted on and measures the flow rate through main feed line 105 and a pressure sensor 113 is mounted on and measures the pressure within manifold 111.

Three liquid distribution lines 117, 118 and 119 are shown connected to the manifold 111. Each liquid distribution line 117-119 extends to a different section of a row unit and four pairs of valves 120, including A valves 120A and B valves 120B are connected to each liquid distribution line 117-119 with each valve pair 120 mounted on or positioned in close proximity to each row or row unit of the implement. Outlet tube connectors 123 A and 123B are connected to each of the group A and group B valves 120A and 120B respectively. Branch tubes 125A and 125B are connected to each outlet tube connector 123A and 123B respectively, one set of which is shown in FIG. 8. The branch tube 125A connected to outlet tube connector 123A and associated with valve 120A has a smaller internal diameter than the branch tube 125B connected to outlet tube connector 123B and associated with valve 120B. A y-connector 127 is connected to the ends of the branch tubes 125A and 125B and a discharge tube 128 with a nozzle 129 on the distal end thereof is connected to the y-connector so that the liquid distributed through branch tubes 125A and 125B are dispensed out of a common nozzle 129 or outlet opening.

A controller or control assembly 132 communicates with the flow meter 112, pressure sensor 113, pump 4 and each of the valves 120A and 120B to implement a control strategy similar to that used with the liquid distribution system 1.

It is to be understood that while certain forms of the present invention have been illustrated and described herein, it is not to be limited to the specific forms or arrangement of parts described and shown.

What is claimed and desired to be secured by Letters Patent is as follows:

1. A system for controlling the flow of liquid to a plurality of row units of an agricultural implement comprising:
a trunk line;
a plurality small diameter tubes having a first internal diameter;
a plurality of large diameter tubes having a second internal diameter which is larger than the first internal diameter;
each of the small diameter tubes is paired with a respective one of the large diameter tubes and flow connected to a common outlet associated with a respective row unit;
one or more valves connected between the trunk line and the plurality of small diameter tubes and between the trunk line and the plurality of large diameter tubes; the trunk line delivering liquid under pressure to the one or more valves, and the one or more valves selectively controlling the flow of liquid to:
only the plurality of small diameter tubes; or
only the plurality of large diameter tubes; or
both the plurality of small diameter tubes and the plurality of the large diameter tubes;
a pressure sensor that senses a pressure of the liquid in the trunk line;
a controller in communication with the pressure sensor and the one or more valves and controlling the one or more valves to initially deliver liquid only through the plurality of small diameter tubes until the pressure sensed by the pressure sensor exceeds a maximum set pressure and then controlling the one or more valves to deliver liquid only through the plurality of large diameter tubes until the pressure sensed by the pressure sensor exceeds the maximum set pressure and then controlling the one or more valves to deliver liquid through both the plurality of small diameter tubes and the plurality of large diameter tubes.

2. The system as in claim 1 wherein the controller communicates with the pressure sensor and the one or more valves such that when the one or more valves are delivering liquid only through the plurality of large diameter tubes and the pressure sensed by the pressure sensor drops below a minimum set pressure, the controller controls the one or more valves to deliver liquid only through the plurality of small diameter tubes, and when the one or more valves are delivering liquid through both the plurality of small diameter tubes and the plurality of large diameter tubes and the pressure sensed by the pressure sensor drops below the minimum set pressure, the controller controls the one or more valves to deliver liquid only through the plurality of large diameter tubes.

3. A system for controlling the flow of liquid to a plurality of row units of an agricultural implement comprising:
a trunk line;
a plurality small diameter tubes having a first internal diameter;
a plurality of large diameter tubes having a second internal diameter which is larger than the first internal diameter;
each of the small diameter tubes is paired with a respective one of the large diameter tubes and flow connected to a common outlet associated with a respective row unit;
one or more valves connected between the trunk line and the plurality of small diameter tubes and between the trunk line and the plurality of large diameter tubes; the trunk line delivering liquid under pressure to the one or more valves, and the one or more valves advanceable between:
a low flow state in which liquid is only delivered to the plurality of small diameter tubes;
a medium flow state in which liquid is only delivered to the plurality of large diameter tubes; or
a high flow state in which liquid is delivered to both the plurality of small diameter tubes and the plurality of the large diameter tubes;
a pressure sensor for sensing the pressure of the liquid in the trunk line;
a controller in communication with the pressure sensor and the one or more valves and controlling the one or more valves:
to initially position the one or more valves in the low flow state; and
when the one or more valves are in the low flow state, if the pressure sensed by the pressure sensor exceeds a maximum set pressure to advance the one or more valves to the medium flow state; and
when the one or more valves are in the medium flow state, if the pressure sensed by the pressure sensor exceeds the maximum set pressure to advance the one or more valves to the high flow state or if the pressure sensed by the pressure sensor falls below a minimum set pressure to advance the one or more valves to the low flow state; and
when the one or more valves are in the high flow state, if the pressure sensed by the pressure sensor falls below a minimum set pressure to advance the valves to the medium flow state.

4. A system for controlling the flow of liquid to a plurality of row units of an agricultural implement comprising:
a trunk line;
a plurality small diameter tubes having a first internal diameter;
a plurality of large diameter tubes having a second internal diameter which is larger than the first internal diameter;
each of the small diameter tubes is paired with a respective one of the large diameter tubes and flow connected to a common outlet associated with a respective row unit;
at least one small tube valve connected between the trunk line and the plurality of small diameter tubes for selectively controlling the flow of liquid from the trunk line to the plurality of small diameter tubes;
at least one large tube valve connected between the trunk line and the plurality of large diameter tubes for selectively controlling the flow of liquid from the trunk line to the plurality of large diameter tubes;
the trunk line delivering liquid under pressure to the small tube valve and the large tube valve;
a pressure sensor for sensing the pressure of the liquid in the trunk line;
a controller communicating with the pressure sensor and the small tube valve and the large tube valve and controlling the small tube valve and the large tube valve:
to initially open only the small tube valve; and
when only the small tube valve is open, if the pressure sensed by the pressure sensor exceeds a maximum set pressure, to close the small tube valve and open the large tube valve, and
when only the large tube valve is open, if the pressure sensed by the pressure sensor exceeds the maximum set pressure to open the small tube valve while leaving the large tube valve open or if the pressure sensed by the pressure sensor falls below a minimum set pressure to open the small tube valve and close the large tube valve; and
when both the large tube valve and the small tube valve are open, if the pressure sensed by the pressure sensor falls below a minimum set pressure to close the small tube valve while leaving the large tube valve open.

5. The system as in claim 4 wherein each of said common outlets associated with each row unit comprises a nozzle.

6. The system as in claim 4 further comprising a pump flow connected to said trunk line.

7. A system for controlling the flow of liquid to a plurality of row units of an agricultural implement comprising:
a trunk line;
first and second sets of small diameter tubes each small diameter tube having a first internal diameter;
first and second sets of large diameter tubes each large diameter tube having a second internal diameter which is larger than the first internal diameter;
each of the small diameter tubes is paired with a respective one of the large diameter tubes and flow connected to a common outlet associated with a respective row unit;
a first small tube valve connected between the trunk line and the first set of small diameter tubes for selectively controlling the flow of liquid from the trunk line to the first set of small diameter tubes;
a second small tube valve connected between the trunk line and the second set of small diameter tubes for selectively controlling the flow of liquid from the trunk line to the second set of small diameter tubes;
a first large tube valve connected between the trunk line and the first set of large diameter tubes for selectively controlling the flow of liquid from the trunk line to the first set of large diameter tubes;
a second large tube valve connected between the trunk line and the second set of large diameter tubes for selectively controlling the flow of liquid from the trunk line to the second set of large diameter tubes;
the trunk line delivering liquid under pressure to the first and second small tube valves and the first and second large tube valves;
a pressure sensor for sensing the pressure of the liquid in the trunk line;
a controller communicating with the pressure sensor and the first and second small tube valves and the first and second large tube valves and controlling the first and second small tube valves and the first and second large tube valves:
to initially open only the small tube valves; and
when only the small tube valves are open, if the pressure sensed by the pressure sensor exceeds a maximum set pressure, to close the small tube valves and open the large tube valves, and
when only the large tube valves are open, if the pressure sensed by the pressure sensor exceeds the maximum set pressure to open the small tube valves while leaving the large tube valves open or if the pressure sensed by the pressure sensor falls below a minimum set pressure to open the small tube valves and close the large tube valves; and
when both the large tube valves and the small tube valves are open, if the pressure sensed by the pressure sensor falls below a minimum set pressure to close the small tube valves while leaving the large tube valve opens; and
a mounting bracket to which said first and second set of small tube valves are mounted in a first section and to which said first and second large tube valves are mounted in a second section.

8. The system as in claim 7 wherein each of said common outlets associated with each row unit comprises a nozzle.

9. The system as in claim 7 further comprising a pump flow connected to said trunk line.
